(19) United States
(12) Patent Application Publication
(10) Pub. No.: US 2023/0267592 A1
(43) Pub. Date: Aug. 24, 2023

(54) INFORMATION PROCESSING DEVICE, COMPUTER-EXECUTABLE METHOD, AND COMPUTER-READABLE STORAGE MEDIUM

(71) Applicant: FANUC CORPORATION, Yamanashi (JP)

(72) Inventors: Yasuhiro SHIBASAKI, Yamanashi (JP); Kazuhiro SATOU, Yamanashi (JP)

(21) Appl. No.: 18/040,151

(22) PCT Filed: Aug. 12, 2021
(86) PCT No.: PCT/JP2021/029740

§ 371 Date: Feb. 1, 2023

(30) Foreign Application Priority Data
Aug. 17, 2020 (JP) 2020-137491

(51) Int. Cl. G06T 7/00

(52) U.S. Cl. CPC G06T 7/0004; G06T 2207/10048; G06T 2207/30164

(57) ABSTRACT

This information processing device acquires time series quantitative data associated with an industrial machine and divides the quantitative data into sections (i.e., sections associated with an event of interest for data analysis) determined on the basis of a context. Moreover, a coordinate of a first axis indicative of a time within the divided sections and a coordinate of a second axis indicative of a division order of the sections in a display screen are calculated. Then, at the coordinate of the first axis and the coordinate of the second axis in the display screen, a point visually representing the quantity of the quantitative data is plotted.

### TECHNICAL FIELD

The present invention relates to an information processing device for visualizing data associated with an industrial machine, a computer executable method for visualizing the data associated with the industrial machine, and a computer readable storage medium for storing a command for visualizing the data associated with the industrial machine.

### BACKGROUND ART

Currently, technologies for monitoring a condition of an industrial machine to utilize the monitoring results for promoting control efficiency and mechanical maintenance are known. These technologies can collect data associated with an industrial machine and analyze the collected data, so as to grasp the condition of the machine.

Data analysis is a technique for searching knowledge contained in data. The data is a series of numerical values, and it is thus difficult to analyze them as they are. Thus, in the data analysis, the size and trend of change represented by the data are reformed to the size and orientation of figures for easy visual understanding. This is so-called data visualization and is a very important technology in the field of data analysis.

The data visualization facilitates data interpretation, thereby enabling to summarize the data, grasp the data, and perform factor analysis on results, by way of example. In addition to that, knowledge acquired by the data visualization can be used as a tool for the data analysis. The knowledge can be also utilized for statistics analysis and establishing a model for machine learning.

For example, Patent Literature 1 teaches an abnormality diagnosis device for diagnosing abnormal states of various processes, e.g., a manufacturing process for a manufacturing facility, such as steel manufacturing facility, a power generation process for a power-generating facility, and a transportation process for a transportation facility, in which, for example, (1) a definition is provided for each sub-model that is a mathematical formula showing a relationship between, such as, a condition of a material before manufacture, a setting of a facility before manufacture, a condition of the facility during manufacture, and a condition of a product during and/or after manufacture, (2) calculation of a deviation index is made that is a value calculated from a difference value or a ratio between a predictive value calculated from the sub-model and an actual value of a manufacturing process corresponding to the predictive value, (3) a heat map is generated that shows the deviation index calculated for each sub-model on its vertical axis and a time transition on its horizontal axis, and thus (4) a temporal change in the deviation index of each sub-model is visualized.

### PRIOR ART DOCUMENT

### Patent Literature

[Patent Literature 1] PCT International Publication No. WO 2018/235807

### SUMMARY OF THE INVENTION

### Problems to Be Solved by the Invention

In general, data analysis is carried out in such a way that data are visualized, knowledge is acquired by visual perception (or visual perception is increased by presupposed knowledge), and a hypothesis is made based on the acquired knowledge to further develop pursuit and analysis. Then, specifications of visualization are revised according to the analysis result and processes for obtaining a new visualization result are repeated.

Typical procedure for visualizing data include overview display, enlarged display, filtering and detailed display. A user browses overviews of data, focuses on a needed part (enlarges the needed part), conducts filtering to process input information to display detailed information that is not yet displayed.

In this way, in the initial stage of the data analysis, the user browses the data and grasps an overall view of the data. By visualizing data themselves or visualizing a relation between the concerned data and other data, it is possible to gain new knowledge and a deeper understanding of the data, leading to establishment of a model or formulation of a hypothesis regarding machine learning.

In the field of data analysis of industrial machinery, there is a demand for a technology to visualize an overview of data indicating a condition of an industrial machine.

### Means for Solving the Problem

One aspect of the disclosure is an information processing device including: a quantitative data acquirer configured to acquire time-series quantitative data associated with an industrial machine; a splitter configured to split the time-series quantitative data into sections defined by context; and an overview image generator configured to calculate a coordinate of a first axis representing a time in a split section and a coordinate of a second axis representing a split order in the sections, and plots a dot that visually represents an amount of the quantitative data at the coordinate of the first axis and the coordinate of the second axis.

One aspect of the disclosure is a computer-executable method for visualizing data associated with an industrial machine, the method including: splitting time-series quantitative data associated with the industrial machine into sections defined by context, calculating a coordinate of a first axis representing a time in a split section and a coordinate of a second axis representing a split order of the sections, generating an overview image in which a dot that visually represents an amount of the quantitative data is plotted at the coordinate of the first axis and the coordinate of the second axis, and displaying the overview image on a display device.

One aspect of the disclosure is a computer-readable storage medium for storing a command executable by one or more processors, wherein when the command is executed, the storage medium causes the one or more processors to conduct: acquisition of time-series quantitative data associated with an industrial machine; split of the time-series quantitative data into sections defined by context; calculation of a coordinate of a first axis representing a time in a split section and a coordinate of a second axis representing a split order in the unit; and generation of an overview image in which a dot that visually represents an amount of the quantitative data is plotted at the coordinate of the first axis and the coordinate of the second axis.

### Effect of the Invention

In accordance with the disclosure, an overview of data indicating a condition of an industrial machine can be visualized.

### BRIEF DESCRIPTION OF THE DRAWINGS

FIG. 1 shows a relationship between an information processing device according to the disclosure and external equipment;

FIG. 2 is a hardware configuration diagram of the information processing device;

FIG. 3 is a block diagram of the information processing device;

FIG. 4 shows an example of working processes;

FIG. 5 is a conceptual diagram of an overview image;

FIG. 6 shows an example of a detailed image;

FIG. 7 shows an example of a detailed image on which multiple pieces of waveform data are superimposed;

FIG. 8 is a block diagram of an information processing device according to a second disclosure;

FIG. 9 shows an example of the detailed image;

FIG. 10 shows an example of an overview image generated without preprocessing;

FIG. 11 shows an example of the overview image generated with preprocessing;

FIG. 12 shows an example of a detailed image subjected to the FFT as preprocessing;

FIG. 13 shows an example of an overview image generated without preprocessing other than the FFT;

FIG. 14 shows an example of an overview image generated with preprocessing other than the FFT;

FIG. 15 is a conceptual diagram of an overview image containing a blank period;

FIG. 16 shows an example of an overview image including a scroll bar;

FIG. 17 shows an example displaying two overview images in a normal time and an abnormal time side by side; and

FIG. 18 shows an example displaying overview images of different pieces of data side by side.

### MODE FOR CARRYING THE INVENTION

### First Disclosure

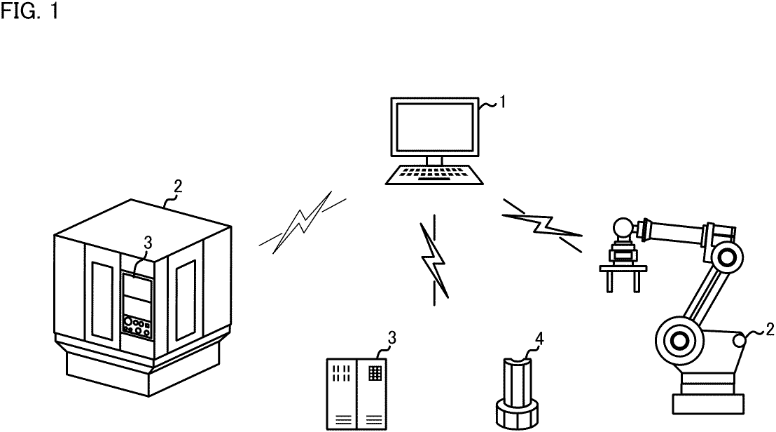

Hereinafter, an example of an information processing device 1 according to the present disclosure will be described. The information processing device 1 can acquire, as shown in FIG. 1, data associated with an industrial machine 2 from a sensor 4 attached to the industrial machine 2, a controller 3 in the industrial machine 2, or the industrial machine itself. The data may be acquired via a wired or wireless network, or from a portable non-volatile memory, such as flash memory.

The information processing device 1 includes in its scope various devices, such as a personal computer, a server, a tablet terminal, a mobile phone and a numerical control device. However, the information processing device 1 is not limited to these devices as long as it has a calculator unit and a storage.

The sensor 4 may be an electric current sensor, a temperature sensor, an acceleration sensor, a displacement sensor, a sound sensor, a color sensor, an odor sensor, etc. The sensor is used in acquiring data indicating a condition of the industrial machine 2 concerning electric current, temperature, vibration, tilt, operating sound, color, odor and so on. The sensor 4 is not limited to the above-mentioned sensors as long as the sensor can acquire data indicating the condition of the industrial machine 2.

The controller 3 in the industrial machine 2 may be a numerical control device, a PLC (Programmable Logic Controller) or similar. In addition, the controller 3 may be incorporated into the industrial machine 2. However, the controller 3 in the industrial machine 2 is not limited to the above-described ones as long as the machine is configured to acquire data of the industrial machine 2 and then control the industrial machine 2.

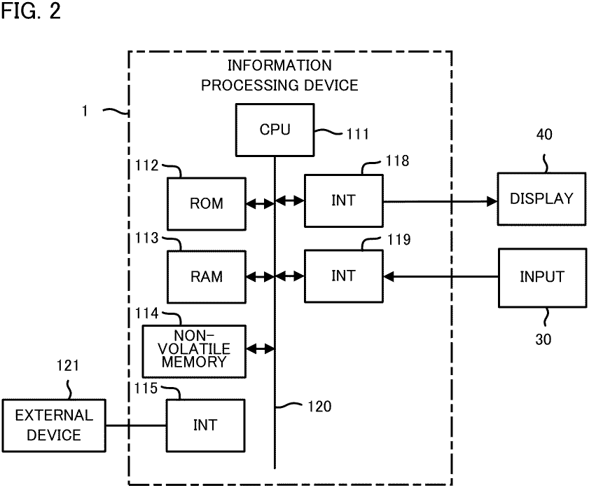

The information processing device 1 includes, as shown in FIG. 2, a central processing unit (CPU) 111 for controlling the information processing device 1 as a whole, a read-only memory (ROM) 112 for recording programs and pieces of data, a random-access memory (RAM) 113 for temporarily loading pieces of data therein. The CPU 111 is configured to read a system program stored in the ROM 112 via a bus 120 to thereby control the information processing device 1 as a whole in accordance with the system program.

For example, a non-volatile memory 114 is backed up by a battery, not shown, so as to retain a state of storage of data written therein even when a power source of the information processing device 1 is turned off. The non-volatile memory 114 is configured to store programs read from an external device 121 via interfaces 115, 119, user operations which are input via an input unit 30, and various data obtained from components in the information processing device 1, the industrial machine 2 and others (e.g., set parameters and sensor information).

The interface 115 is for connecting the information processing device 1 to the external device 121, such as an adaptor. Programs, various parameters and others can be read from the external device 121. In addition to that, programs, various parameters and others edited in the information processing device 1 can be stored in external storing means, not shown, via the external device 121.

The information processing device 1 is connected to via an interface 118 a display unit 40. The information processing device 1 displays an overview image and a detailed image on the display 40, which will be described later. A program for visualizing data may be stored in the non-volatile memory 114 or the external storing means, or may be obtained through a network. The CPU 111 in the information processing device 1 executes the program to generate the overview image or the detailed image in order to achieve data visualization.

### First Disclosure

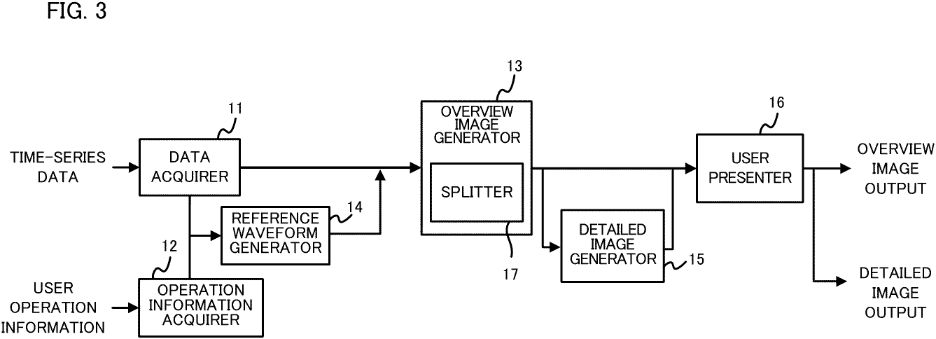

FIG. 3 is a block diagram of the information processing device 1. The information processing device 1 includes a data acquirer 11 for acquiring data associated with the industrial machine 2, an operation information acquirer 12 for acquiring information on user operations, an overview image generator 13 for generating the overview image of acquired data, a reference waveform generator 14 for generating a reference waveform, a detailed image generator 15 for generating the detailed image, and a user presenter 16 for displaying the overview image and the detailed image on the display.

The data acquirer 11 is configured to acquire data associated with the industrial machine 2. The data to be acquired are time-series quantitative data. Traditionally, time-series quantitative data have been displayed as waveforms on a two-dimensional plane. This disclosure refers to these images as waveform data.

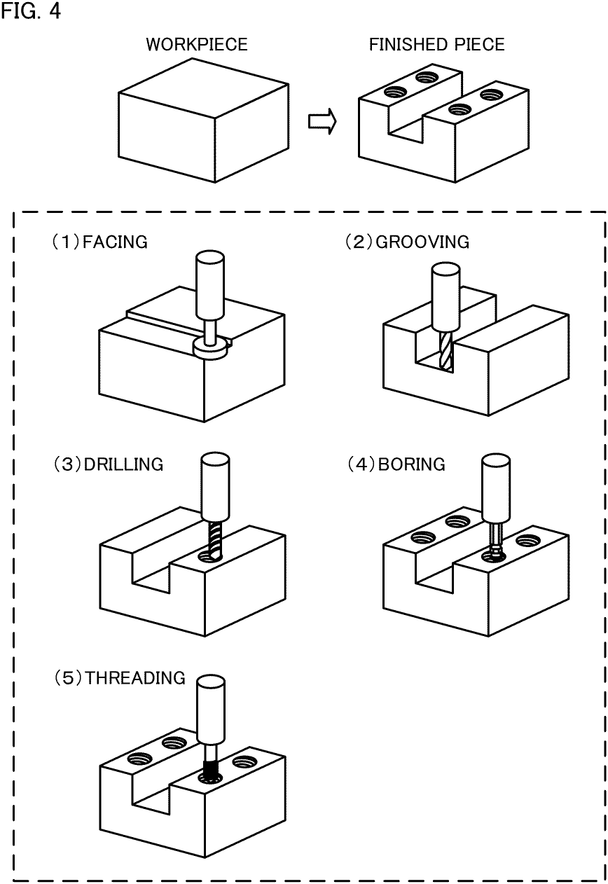

The overview image generator 13 includes a splitter 17 for splitting the data associated with the industrial machine 2 into sections defined by a context. The section defined by the context means a section associated with an event of interest in a data analysis. Taking a machine tool as an example of an industrial machine, a part of or a whole machining may be regarded as one section. The machining shown in FIG. 4 is one for forming a groove on the middle portion of a workpiece W and further forming two threaded holes respectively on both convex sides of the groove, as shown in the upper part in the Figure. This machining includes the following five steps: (1) facing; (2) grooving; (3) drilling; (4) boring; and (5) threading.

In order to split data for conducting such machining, the data can be split with each of steps (1) to (5) as one section.

In the facing of step (1), the same process is repeated to shave the top surface of a workpiece. Thus, the data can also be split with the start to end of a single cutting process as one section.

In steps (3), (4) and (5), the same process is repeated to the number of holes. Thus, the data can be split with a process for forming one hole as one section in steps (3), (4) and (5).

The data can also be split with entire steps (1) to (5), from the start of the machining of the workpiece to the formation of a processed product, as one unit.

Furthermore, in a case where an event, such as beginning or end of cutting, is the focus of interest, the data may be extracted only for the portion of interest.

The split position in the data can be detected based on the shape of a data waveform. For example, in a case where the machine tool repeats a sequence of actions, the data can be split based on the characteristics of the data, such as rising or falling edge in the data.

The split position can also be determined based on a control signal. The control signal is output by a PLC (Programmable Logic Controller) or a numerical control device connected to the industrial machine 2, or a controller in the industrial machine 2.

The split section can be designated by a user in advance. For example, if the user focuses on a section of data indicative of the end of cutting in the drilling process in step (3), the user designates the concerned section to generate an overview image of only data on the section in the data designated by the user.

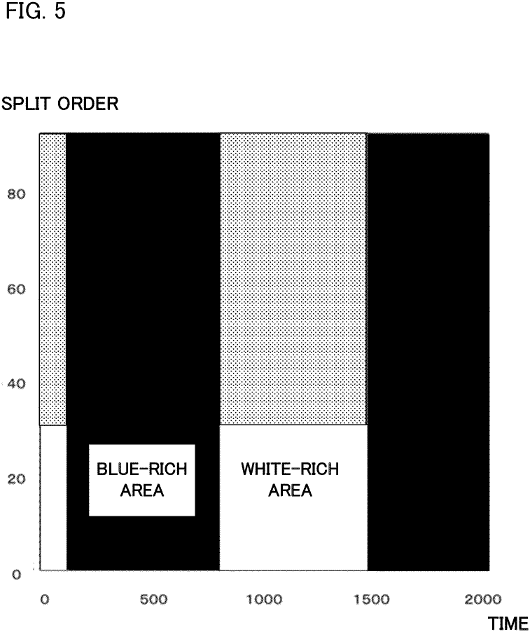

The overview image generator 13 is configured to generate an overview image of the split data arranged by the context. FIG. 5 shows an example of the overview image. The overview image in FIG. 5 shows a change in a value of a torque command when the drilling is conducted by a drill.

The torque command means a speed command for a servomotor. The control device feeds a rotational speed back to the servomotor, so as to reflect a difference between the output command and an actual rotational speed in the torque command to output the reflected command. The torque command is an order rather than a sensor value, but is determined based on an actual physical phenomenon. Thus, the disclosure regards the command as data indicating the condition of the industrial machine.

The overview image generator plots the size (level) of the torque command on an XY plane with a horizontal axis (X-axis) representing a time in a section and a vertical axis (Y-axis) representing a split order. FIG. 5 shows a conceptual diagram therefor. The Figure indicates the level of the torque command in color, wherein white means the torque command during cutting is close to a normal level, blue means the torque command is lower than the normal level, and red means the torque command is higher than the normal level. As can be seen from the overview image, the darker the red, the higher the torque command is above the normal level, and the darker the blue, the lower the torque command is above the normal level.

In the overview image in FIG. 5, the first data in the split order is plotted in time series at Y=0, the second data in the split order is plotted in time series at Y=1, and the third data in the split order is plotted in time series at Y=3. In this way, the pieces of the split data are layered in the split order in the overview image. Newer data is lined up in the upper part of the figure, visually representing changes in the torque command.

In FIG. 5, one section is from the midstream to the end of drilling or from the start to the end of the next drilling. A torque command for the drilling has a rising edge at the start of the drilling and a falling edge at the end of the drilling. FIG. 5 shows that the drilling starts with a relatively high torque command at X=0, and that the torque command first falls and rises again, and then falls again.

With reference to FIG. 5, dots of the torque command during the drilling become smaller around the thirtieth split order. This is because a tool was replaced. The overview image provides knowledge that the torque command value gets closer to the normal level by the tool replacement, and gradually increases by continuous use of the tool.

The change in the data will be a message that informs timing of replacing the tool. Because the change in the condition of the industrial machine appears in the data, appropriate visualization of data enables the acquisition of knowledge from the data.

The torque command value may be represented by brightness or a dot size. Furthermore, a three-dimensional image may be generated to express the size of the torque command by three-dimensional height. The method for displaying the torque command value is not restricted as long as it can be represented in a visual manner. In this connection, an image that represents a torque command value in color is also called as a heat map image.

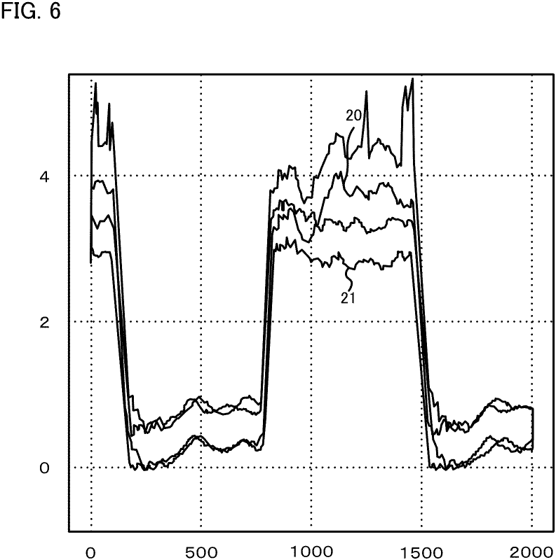

The detailed image generator 15 is configured to generate a detailed image in response to instructions from the user. FIG. 6 shows an example of the detailed image. This detailed image shows that the horizontal axis (X-axis) of the image represents a time in a section, and that a level of a torque command is plotted on the vertical axis (Y-axis) of the image.

FIG. 6 shows a waveform 20 representing the transition of the torque command. FIG. 6 shows a reference waveform 21 as well as waveforms of torque commands for which the user instructed to display in detail. The reference waveform 21 is a waveform of the torque command at Y=0, by way of example. Displaying multiple waveforms enables comparison with other data.

In the detailed display, the reference waveform 21 may be highlighted by line thickness or in color. The reference waveform 21 may also be highlighted with a certain sign such as an arrow. The way of highlighting is not limited to certain ways.

The reference waveform is not limited to the waveform at Y=0. The average value of all waveforms may be used as the reference waveform 21. Alternatively, a waveform generated during replacing the tool may be used as the reference waveform 21.

Use of such detailed image shown in FIG. 6 enables visually displaying of the accurate value of a torque command. As shown in FIG. 6, by displaying the detailed image and the overview image side by side, the level of the torque command can be determined accurately while visually confirming the change in each waveform. It is possible to deepen the understanding of the data by showing the data in its entirety with the overview image and presenting a part to be focused with the detailed image.

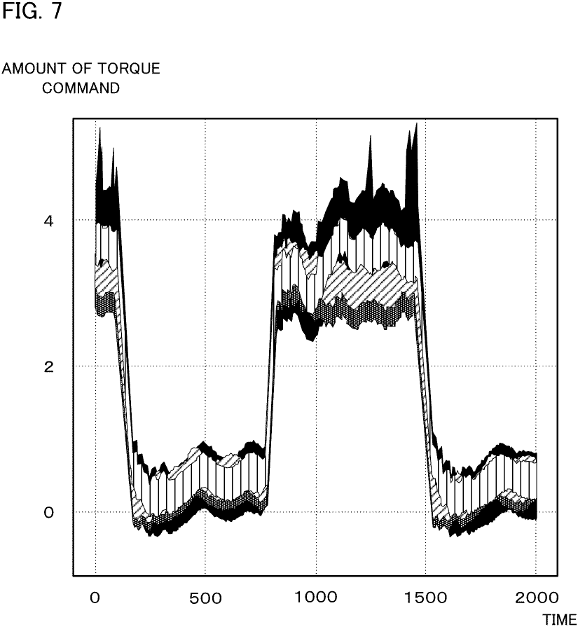

Furthermore, the overview image can be selected from the detailed image. FIG. 7 shows a detailed image on which multiple pieces of waveform data are superimposed. It is difficult to visually classify the waveforms in the detailed image in FIG. 7 because many pieces of waveform data are superimposed. Thus, a waveform of interest is selected, and overview images before and after this waveform was observed are displayed, so as to be able to visually understand former and latter changes in data to be analyzed.

The first disclosure splits time-series quantitative data into sections by equal contexts, and arranges the data vertically while visualizing the amount of data, thereby providing the overview image that enables the visual understanding of the data in its entirety.

### Second Disclosure

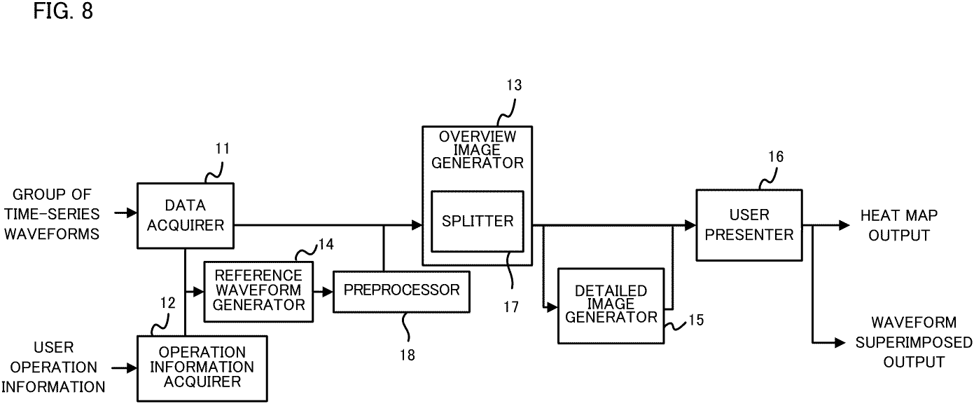

FIG. 8 is a block diagram of an information processing device 1 according to a second disclosure. The information processing device 1 includes a data acquirer 11 for acquiring data associated with the industrial machine 2, an operation information acquirer 12 for acquiring information on user operations, a reference waveform generator 14 for making a reference waveform, a preprocessor 18 for conducting preprocessing on the acquired data, an overview image generator 13 for generating an overview image of the acquired data, a reference waveform generator 14 for generates a reference waveform, a detailed image generator 15 for generating a detailed image of the acquired data, and a user presenter 16 for making the overview image and the detailed image displayed on a display unit 40.

In this disclosure, the data acquirer 11, the operation information acquirer 12, the reference waveform generator 14, the detailed image generator 15 and the user presenter 16 are similar to those in the information processing device 1 in the first disclosure shown in FIG. 3, and thus the elucidation about them is omitted.

The information processing device 1 in the second disclosure includes the preprocessor 18 for data preprocessing. The preprocessor 18 is configured to perform moving average calculation, frequency calculation, difference calculation from a reference waveform, for instance.

The moving average is an average value for each certain section in time-series data obtained by shifting sections. When the moving average is used to draw a graph, a smooth curve indicating a long-term trend can be obtained. Most simple moving average can be obtained by calculating a simple arithmetic mean of the last data. More specifically, it is a method for averaging out by adding some pieces of data before and after central data for which the moving average is to be obtained. By obtaining the moving average, the waveform is smoothed, thereby enabling to obtain data that is smooth to some extent while maintaining the characteristics of original data. Even though data of an industrial machine contains noise, the noise is smoothed by obtaining the moving average, and thus data visibility is increased.

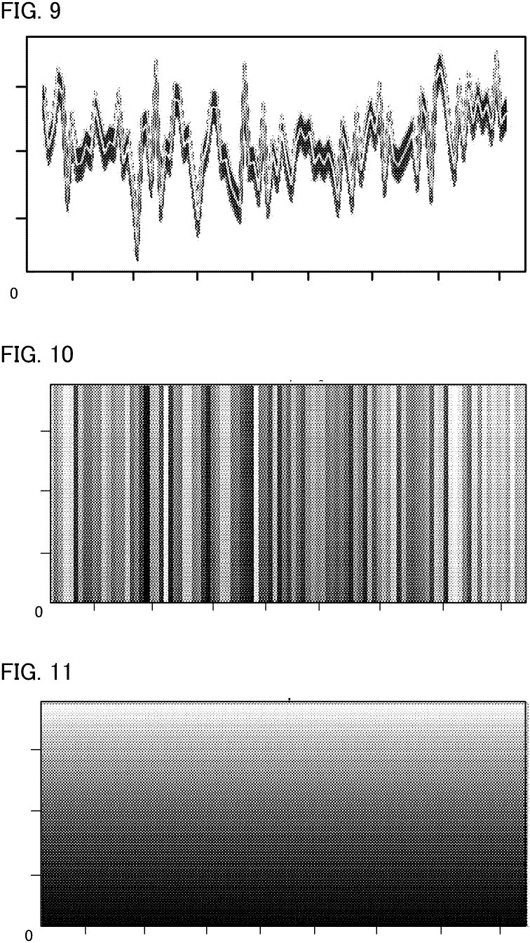

FIG. 9 shows a detailed image of a piece of data. This piece of data is finely fluctuating because the data contains noise. When an overview image is generated from the data without preprocessing, an image shown in FIG. 10 is obtained. In this way, when no preprocessing is conducted, the image looks like vertical bars lined up side by side. The preprocessing, such as data smoothing, data interpolation, normalization, standardization or logarithmic transformation, produces gradation that gradually becomes light color from the bottom to the top of the figure, as shown in FIG. 11. Consequently, it is possible to visually represent fine changes in data that is difficult to grasp from a detailed image that is not subjected to the preprocessing.

The frequency calculation is for performing the FFT (Fast Fourier Transform), for instance. The overview image generator generates an overview image with the level of each frequency presented in color or by a dot size, wherein a frequency is represented on the horizontal axis (X-axis) and a data split order is represented on the vertical axis (Y-axis).

The waveform associated with an industrial machine may be a waveform in which vibrations generated from components that constitute the machine are combined. The frequency position corresponding to the vibration generated from each component is determined according to the structure of the machine. Frequency resolution using the FFT is conducted to study how much change occurred in which frequency level and from which component the frequency is generated, thereby enabling to estimate a cause of an abnormality and the component where the abnormality is occurring.

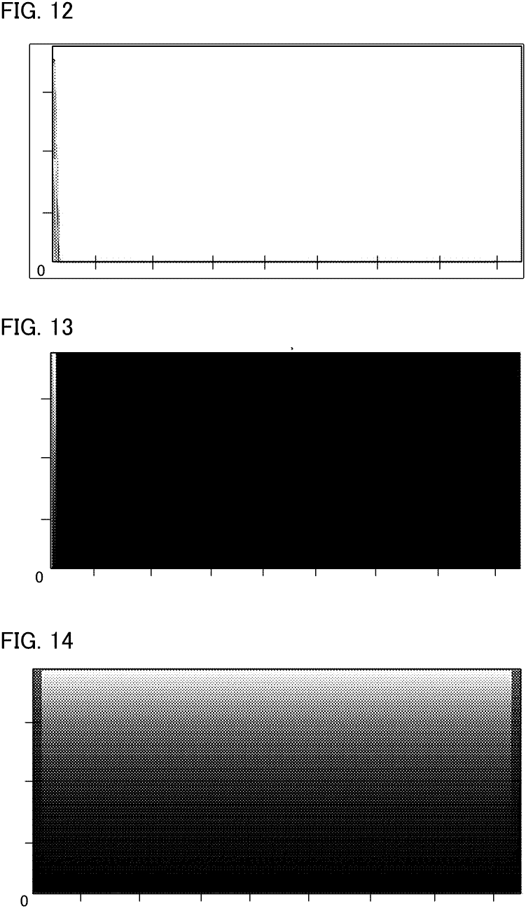

FIG. 12 shows an example of a detailed image presenting a case where the FFT is conducted as the preprocessing. The detailed image in FIG. 12 is an example presenting a piece of data being subjected to the FFT. The vertical axis in FIG. 12 represents a level of the data subjected to the FFT. The horizontal axis of FIG. 12 represents a frequency. This data is converted into a heat map (overview image), on which, as shown in FIG. 13, a slight change in a frequency band can be seen as longitudinal gradation at the left end, but the remaining frequency bands are solid monochrome, and thus the change in the data cannot be grasped visually.

Then, when the preprocessing, such as data smoothing, data interpolation, normalization, standardization or logarithmic transformation, is conducted, monochrome portions are produced at the left end and the right end of the vertical axis, as shown in FIG. 14, and gradation that gradually becomes light color from the bottom to the top of the Figure is generated in the frequencies between the monochrome portions. This can visually present a small change in the data that is difficult to grasp in the detailed image shown in FIG. 13.

Characteristics of some pieces of data associated with the industrial machine 2 may be clarified by the preprocessing. Thus, the information processing device 1 in the second disclosure conducts the preprocessing on the data to generate more visible overview image.

### Third Disclosure

The third disclosure is for displaying a difference from a reference waveform. In calculation of the difference from the reference waveform, an appropriate waveform is set to the reference waveform, and the difference between the reference waveform and a waveform to be plotted is calculated, so as to generate an overview image by plotting the magnitude (amount) of the difference on the XY plane with the horizontal axis (X-axis) of an image representing a time in a section and the vertical axis (Y-axis) of the image representing a split order.

In a case where Y=0 is the reference waveform, when the difference from the reference waveform is taken for a torque command during drilling, the difference from the reference waveform may suddenly increase at a region where the split order presents (e.g., in the vicinity of 30th in the order). It is deemed to be caused by tool replacement.

The range of the difference from the reference waveform is narrower than that of raw data. Because the range becomes narrower, even fine changes can be expressed.

In this disclosure, the waveform at Y=0 is used as the reference waveform. However, the average value of all waveforms may be used as the reference waveform. Alternatively, a waveform when the tool is replaced may be used as the reference waveform. It is not limited which waveform is set to the reference waveform.

### Fourth Disclosure

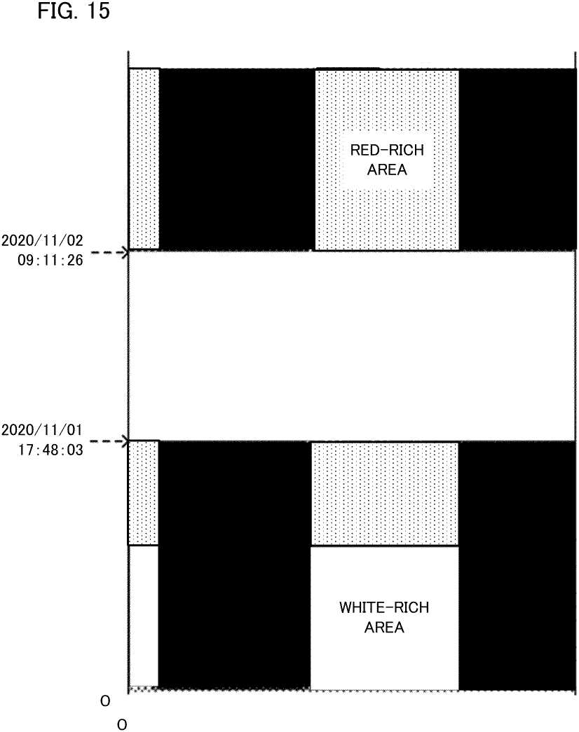

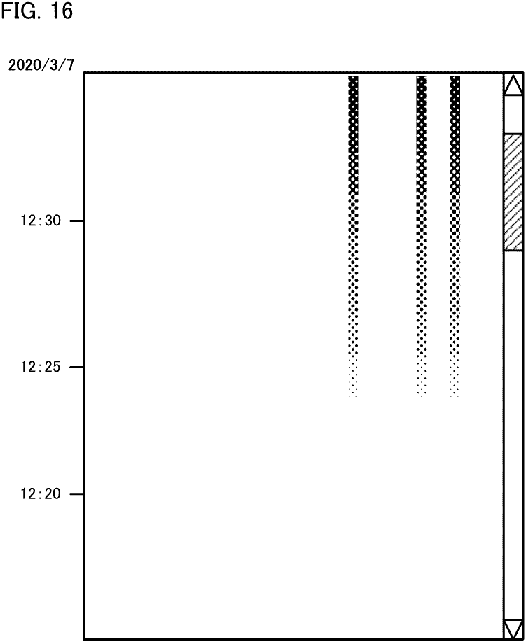

The overview image shown in FIG. 15 according to the fourth disclosure includes a blank portion between pictures. This blank portion represents a blank period. When the industrial machine is operated, data may have intermittent parts because it takes, by way of example, one day from the acquisition of a first waveform group to the acquisition of a second waveform group and one month from the acquisition of the second waveform group to the acquisition of a third waveform group. In this case, the overview image generator provides the blank portion between pictures based on a time that the data is measured, so as to present the blank period.

### Fifth Disclosure

The fifth disclosure is for splitting data by certain time unit as a section defined by context. The time unit is not particularly limited as long as it is easily visible length, such as one minute, one hour or one day. The time unit of data split may be configured to be assigned by a user.

For example, a belt conveyor is continuously running at a constant speed. Motor torque of the belt conveyor continuously measured is divided by predefined time unit and then schematically displayed, so that a summary of continuously recorded data is visually represented. An example shown in FIG. 16 shows that time and date of acquisition of the data are presented on the left part of a display screen and a scroll bar is provided on the right part of the display screen. The scroll bar is an element on the screen for changing a display range of an overview image. By manipulating the scroll bar, the screen image moves up and down, and data to be displayed changes according to the movement of the screen image. The fifth disclosure moves the screen image up and down to represent the flow of time sensuously.

### Sixth Disclosure

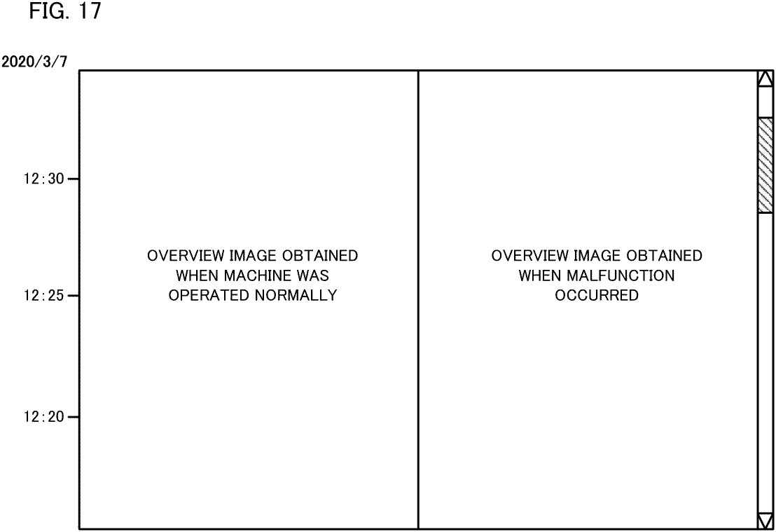

The sixth disclosure is an example of displaying two overview images side by side. For example, FIG. 17 shows an overview image obtained when a malfunction occurs and an overview image obtained when the machine is operated normally, side by side. In the Figure, two images have dates and times of acquisition of data on their left sides, and a scroll bar is provided on the right of a display screen. Normal data is compared with data indicating an occurrence of a malfunction in time series, so as to be able to confirm a state of the data where the malfunction occurs.

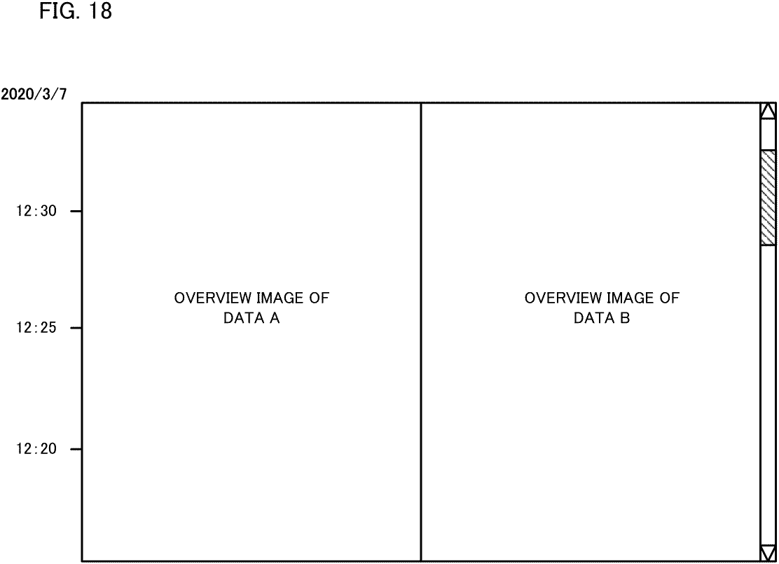

In addition to that, FIG. 18 shows overview images of two different pieces of data arranged side by side. For example, two different pieces of data, such as motor temperatures of a torque command, are shown side by side to compare changes in one of data with respect to the other of data in time series.

Two or more pieces of data may be arranged side by side to visually represent the relationship between multiple data.

Furthermore, the FFT may be conducted on vibrational data and so on to display overview images of level of a low frequency region, a middle frequency region and a high frequency region side by side. It enables a comparison between the states of elements (e.g., motor, coupling, gear, bearing) corresponding to these frequency regions in time series.

As described above, the information processing device according to the disclosure splits time-series quantitative data associated with an industrial machine into sections defined by context, and plot the split data by arranging them vertically in two-dimensional coordinates. This makes it possible to visually grasp a change in a time of the time-series data and a change in an amount of the data, thereby increasing the visibility of the data.

REFERENCE SIGNS LIST

| | |
|---|---|
| 1 | Information Processing Device |
| 2 | Industrial Machine |
| 3 | Controller |
| 4 | Sensor |
| 11 | Data Acquirer |
| 12 | Operation Information Acquirer |
| 13 | Overview Image Generator |
| 14 | Reference Waveform Generator |
| 15 | Detailed Image Generator |
| 16 | User Presenter |
| 17 | Splitter |
| 18 | Preprocessor |
| 30 | Input |
| 40 | Display |

1. An information processing device, comprising:
a quantitative data acquirer configured to acquire time-series quantitative data associated with an industrial machine;
a splitter configured to split the time-series quantitative data into sections defined by context; and
an overview image generator configured to calculate a coordinate of a first axis representing a time in the split section and a coordinate of a second axis representing a split order in the sections, and plots a dot that visually represents an amount of the quantitative data at the coordinate of the first axis and the coordinate of the second axis.

2. The information processing device according to claim 1, wherein the overview image is a heat map image visually representing the amount of the quantitative data in color.

3. The information processing device according to claim 1, wherein the splitter splits the time-series quantitative data based on a process performed by the industrial machine.

4. The information processing device according to claim 1, wherein in a case where the time series of the quantitative data has an intermittent part, the overview image generator visually represents an interval based on a time at which the quantitative data is measured.

5. The information processing device according to claim 1, further comprises a preprocessor for conducting a preprocess on the time-series quantitative data, wherein
the overview image generator generates the overview image based on the preprocessed quantitative data.

6. The information processing device according to claim 5, wherein the preprocessing is at least one of moving average calculation, frequency calculation and difference calculation from a reference value or their combination.

7. The information processing device according to claim 1, wherein the overview image generator moves the overview image along the second axis, and adds an element for changing a display range of the overview image to the overview image.

8. The information processing device according to claim 1, comprising detailed image generating means for generating a detailed image that includes a waveform generated by plotting the amount of the quantitative data at the first coordinate based on a temporal position in the split section, wherein
when a user designates a dot in the overview image, a dot in the detailed image corresponding to the dot in the overview image designated by the user is highlighted.

9. The information processing device according to claim 8, wherein the detailed image is performed such that a reference waveform generated by plotting a predefined reference value is highlighted.

10. The information processing device according to claim 1, wherein the quantitative data is drive information of a servomotor.

11. A computer-executable method for visualizing data associated with an industrial machine, the method comprising:
splitting time-series quantitative data associated with the industrial machine into sections defined by context,
calculating a coordinate of a first axis representing a time in a split section and a coordinate of a second axis representing a split order of the sections,
generating an overview image in which a dot that visually represents an amount of the quantitative data is plotted at the coordinate of the first axis and the coordinate of the second axis, and
displaying the overview image on a display device.

12. A computer-readable storage medium for storing a command executable by one or more processors, wherein when the command is executed, the storage medium causes the one or more processors to conduct:
acquisition of time-series quantitative data associated with an industrial machine;
split of the time-series quantitative data into sections defined by context;
calculation of a coordinate of a first axis representing a time in the split section and a coordinate of a second axis representing a split order in the unit; and
generation of an overview image in which a dot that visually represents an amount of the quantitative data is plotted at the coordinate of the first axis and the coordinate of the second axis.
